(19) United States
(12) Patent Application Publication
(10) Pub. No.: US 2026/0128300 A1
(43) Pub. Date: May 7, 2026

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Yeong Bin YOO, Daejeon (KR); Jong Hwa KIM, Daejeon (KR); Nyung Joo KONG, Daejeon (KR); Sung Soon PARK, Daejeon (KR); Jeong Bae YOON, Daejeon (KR)

(21) Appl. No.: 19/379,768

(22) Filed: Nov. 5, 2025

(30) Foreign Application Priority Data
Nov. 6, 2024 (KR) 10-2024-0156373

(51) Int. Cl. H01M 4/525; C01G 53/42; H01M 10/052

(52) U.S. Cl. CPC H01M 4/525; C01G 53/42; H01M 10/052; C01P 2002/54; C01P 2004/03; C01P 2004/61; C01P 2006/40

(57) ABSTRACT

A cathode active material for a lithium secondary battery includes active material particles that include lithium-transition metal oxide particles having a single particle shape. A particle diameter (D50) of the active material particles at a volume fraction of 50% in a volume-weighted particle size distribution accumulated from particles having the smallest particle diameter is in a range from 2 μm to 10 μm. A volume fraction of particles having a particle diameter of 2a μm or greater among the active material particles is in a range from 4% to 15%, and a represents the D50 of the active material particles.

### CROSS-REFERENCE TO RELATED APPLICATION AND CLAIM OF PRIORITY

This application claims priority to Korean Patent Application No. 10-2024-0156373 filed on Nov. 6, 2024 in the Korean Intellectual Property Office (KIPO), the entire disclosure of which is incorporated by reference herein.

### TECHNICAL FIELD

The present disclosure relates to a cathode active material for a lithium secondary battery and a lithium secondary battery including the same. More particularly, the present disclosure relates to a cathode active material for a lithium secondary battery including a lithium-transition metal oxide and a lithium secondary battery including the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of eco-friendly vehicle such as an electric vehicle, an hybrid vehicle, etc.

Examples of the secondary battery include a lithium secondary battery, a sodium secondary battery, a potassium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

For example, the lithium secondary battery may include an electrode assembly including a cathode, an anode, and a separation layer (separator), and an electrolyte impregnating the electrode assembly. The lithium secondary battery may further include an outer packaging material, e.g., a pouch-shaped packaging material, that accommodates the electrode assembly and the electrolyte.

A lithium metal oxide may be used as a cathode active material of the lithium secondary battery to preferably provide high capacity, high power and enhanced life-span properties. However, when the lithium metal oxide is designed to have high power properties, thermal and mechanical stability may be deteriorated, thereby degrading the life-span properties and operational stability of the lithium secondary battery.

### SUMMARY

According to an aspect of the present disclosure, there is provided a cathode active material for a lithium secondary battery having improved operational stability and life-span properties.

According to an aspect of the present disclosure, there is provided a lithium secondary battery including a cathode active material for a lithium secondary battery with improved operational stability and life-span properties.

A cathode active material for a lithium secondary battery includes active material particles that include lithium-transition metal oxide particles having a single particle shape. A particle diameter (D50) of the active material particles at a volume fraction of 50% in a volume-weighted particle size distribution accumulated from particles having the smallest particle diameter is in a range from 2 μm to 10 μm. A volume fraction of particles having a particle diameter of 2a μm or greater among the active material particles is in a range from 4% to 15%, and a represents the D50 of the active material particles.

In some embodiments, the D50 of the active material particles may be in a range from 2.5 μm to 5 μm.

In some embodiments, the volume fraction of particles having the particle diameter of 2a μm or greater among the active material particles may be in a range from 5% to 10%.

In some embodiments, a volume fraction of particles having a particle diameter of 1 m or less among the active material particles may be 5% or less.

In some embodiments, the volume fraction of particles having the particle diameter of 1 m or less among the active material particles may be in a range from 0.1% to 4.5%.

In some embodiments, a span of the active material particles defined by Formula 1 may be in a range from 1.0 to 1.5.

$$Span = ( D 90 - D 10 ) / D 50 \qquad [ Formula 1 ]$$

In Equation 1, D50 is a particle diameter of the active material particles at the volume fraction of 50% in the volume-weighted particle size distribution accumulated from particles having the smallest particle diameter, D90 is a particle diameter of the active material particles at a volume fraction of 90% in the volume-weighted particle size distribution accumulated from particles having the smallest particle diameter, and D10 is a particle diameter of the active material particles at a volume fraction of 10% in the volume-weighted particle size distribution accumulated from particles having the smallest particle diameter,

In some embodiments, the span of the active material particles may be in a range from 1.1 to 1.4.

In some embodiments, the D10 of the active material particles may be in a range from 1.3 μm to 4 μm.

In some embodiments, the D90 of the active material particles may be in a range from 4 μm to 15 μm.

In some embodiments, the lithium-transition metal oxide particles may include nickel, and a mole fraction of nickel among elements excluding lithium and oxygen in the lithium-transition metal oxide particles may be 0.6 or greater.

In some embodiments, the lithium-transition metal oxide particles may further include at least one element selected from the group consisting of Na, Mg, Ca, Sr, Ba, La, Y, Ti, Zr, Hf, V, Nb, Ta, Cr, Mo, W, Mn, Co, Fe, Cu, Ag, Zn, B, Al, Ga, C, Si and Sn.

In some embodiments, the lithium-transition metal oxide particles may include lanthanum in a content from 500 ppm to 4,000 ppm based on a total weight of the lithium-transition metal oxide particles.

A lithium secondary battery includes a cathode including the above-described cathode active material for a lithium secondary battery, and an anode facing the cathode.

According to embodiments of the present disclosure, active material particles may include lithium-transition metal oxide particles having a single particle shape. Accordingly, cracks of the active material particles or side reactions with an electrolyte solution may be suppressed, thereby improving surface stability. Thus, a lithium secondary battery having improved life-span and cycle properties may be provided.

In example embodiments, a volume fraction of macro-particles of the active material particles may be controlled. Thus, the lithium secondary battery having improved life-span and capacity properties may be provided.

The lithium secondary battery of the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions. etc.

### BRIEF DESCRIPTION OF THE DRAWINGS

FIGS. 1 and 2 are a scanning electron microscope (SEM) images showing a cathode active material for a lithium secondary battery in accordance with example embodiments.

FIGS. 3 and 4 are a schematic plan view and a cross-sectional view, respectively, illustrating a lithium secondary battery in accordance with example embodiments.

FIGS. 5 to 7 are SEM images of cathode active materials for a lithium secondary battery according to Example 1, Example 4 and Comparative Example 1, respectively.

### DETAILED DESCRIPTION OF THE EMBODIMENTS

Embodiments of the present disclosure provide a cathode active material for a lithium secondary battery (hereinafter, that may be abbreviated as a cathode active material) including lithium-transition metal oxide particles and a lithium secondary battery including the cathode active material.

Hereinafter, embodiments of the present disclosure will be described in detail. However, disclosed embodiments are merely provided as examples and the present disclosure is not limited to the specific embodiments.

According to embodiments, the cathode active material includes active material particles including lithium-transition metal oxide particles having a single particle shape.

The term “single particle shape” herein may be used to exclude, e.g., a secondary particle formed by agglomeration or aggregation of multiple primary particles. For example, the lithium-transition metal oxide particles may substantially consist of particles having the single particle shape, and the secondary particles formed by agglomeration or aggregation of the primary particles (e.g., the number of the primary particles in the secondary particle is greater than 10, 20 or more, 30 or more, 40 or more, 50 or more, etc.) may be excluded.

The term “single particle shape” as used herein may not exclude, e.g., a structure in which two to ten single particles are attached or adhered to each other to form a single body or a monolithic body.

In some embodiments, the lithium-transition metal oxide particles may include a structure in which multiple primary particles are merged together and converted into a substantially single particle shape.

For example, the lithium-transition metal oxide particles may have a granular or spherical single particle shape.

For example, the lithium-transition metal oxide particles may include nickel (Ni), and may further include at least one of cobalt (Co) or manganese (Mn).

For example, the lithium-transition metal oxide particles may be represented by Chemical Formula 1 below.

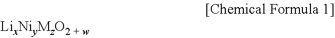

In Chemical Formula 1, 0.9≤x≤1.5, 0.6≤y≤0.99, 0.01≤z≤0.4, and −0.1≤w≤0.1. M may include at least one element selected from Na, Mg, Ca, Sr, Ba, La, Y, Ti, Zr, Hf, V, Nb, Ta, Cr, Mo, W, Mn, Co, Fe, Cu, Ag, Zn, B, Al, Ga, C, Si and Sn.

The chemical structure represented by Chemical Formula 1 may represent bonding relationship included in a layered structure or a crystal structure included in the cathode active material or the lithium-transition metal oxide particle, and does not exclude other additional elements. For example, in Chemical Formula 1, M may include Co and/or Mn, and Co and/or Mn may serve as main active element of the cathode active material together with Ni. Chemical Formula 1 is provided to express the bonding relationship of the main active elements, and is to be understood as a formula encompassing introduction and substitution of the additional elements.

In an embodiment, an auxiliary element may be further included in addition to the main active element to enhance chemical stability of the cathode active material or the layered/crystal structure. The auxiliary element may be incorporated in the layered structure/crystal structure to form a bond, and this case is to be understood as being included within the chemical structure represented by Chemical Formula 1.

The auxiliary element may include at least one selected from the group consisting of, e.g., Na, Mg, Ca, Sr, Ba, La, Y, Ti, Zr, Hf, V, Nb, Ta, Cr, Mo, W, Fe, Cu, Ag, Zn, B, Al, Ga, C, Si and Sn. The auxiliary element may act as an auxiliary active element such as Al which may contribute to capacity/power activity of the cathode active material together with Co or Mn.

The cathode active material may further include a doping element. For example, elements substantially the same as or similar to the above-describe auxiliary elements may be used as the doping element. For example, the above-mentioned elements may be used alone or in a combination of two or more therefrom as the doping element.

In some embodiments, a mole fraction of nickel among elements other than lithium and oxygen in the lithium-transition metal oxide particle may be 0.6 or greater. For example, a molar ratio or a concentration y of Ni in Chemical Formula 1 may be 0.6 or greater, 0.7 or greater, or 0.8 or greater. For example, y may range from 0.6 to 0.99, from 0.7 to 0.98, or from 0.8 to 0.95.

Ni may be provided as a transition metal associated with a power and a capacity of the lithium secondary battery. Thus, a high-power cathode and a high-power lithium secondary battery including the lithium-transition metal oxide particles that may have a high-Ni composition as described above may be provided.

For example, when the high-Ni composition in which the nickel molar fraction y is 0.8 or greater is employed, a calcination of the lithium-transition metal oxide particles may be performed at a relatively low temperature. Accordingly, the lithium-transition metal oxide particles in the form of the single particle may be formed at a relatively low temperature.

In an embodiment, the lithium-transition metal oxide particles may include nickel, cobalt and manganese. For example, the lithium-transition metal oxide particles may include a nickel-cobalt-manganese (NCM)-based lithium oxide. In this case, an NCM-based lithium oxide having an increased nickel content may be used.

In an embodiment, the lithium-transition metal oxide particle may further include at least one element selected from the group consisting of Mg, Ca, Sr, Ba, La, Y, Ti, Zr, Hf, V, Nb, Ta, Cr, Mo, W, Mn, Co, Fe, Cu, Ag, Zn, B, Al, Ga, C, Si and Sn. For example, the lithium-transition metal oxide particles may include nickel, cobalt, manganese and lanthanum. For example, lanthanum contained in the lithium-transition metal oxide particle may be derived from a lanthanum-containing compound provided as a fluxing agent, as will be described later.

In an embodiment, a content of lanthanum based on a total weight of the lithium-transition metal oxide particle may be in a range from 500 ppm to 4,000 ppm, from 1,000 ppm to 3,000 ppm, or from 1,500 ppm to 2,500 ppm. In this range, the single particle having a more uniform shape may be formed at a relatively low temperature.

For example, if the content of lanthanum based on the total weight of the lithium-transition metal oxide particles is excessively increased, non-uniform and macro-particles may be generated. Further, lanthanum may be doped into the crystal structure of the lithium-transition metal oxide to degrade the power and capacity properties.

For example, if the content of lanthanum based on the total weight of the lithium-transition metal oxide particles is excessively decreased, the single particles may not be sufficiently formed. In the above range, the single particles may be formed while preventing excessive formation of the macro-particles. Thus, an initial efficiency of the secondary battery may be increased, and the life-span properties may be further improved while achieving high capacity properties,

For example, nickel may be provided as a metal associated with the capacity of the lithium secondary battery. A higher nickel content may enhance the capacity and output properties of the lithium secondary battery, but an excessive increase in the nickel content may cause reduced life-span, and mechanical and electrical stability.

For example, as the nickel content increases, a volume change of the oxide particles during repeated charge/discharge cycles may be increased. Accordingly. cracks in the oxide particles or side reactions with the electrolyte solution may be caused to degrade structural stability. Thus, a sufficient capacity retention may not be achieved during repeated charge/discharge cycles at high temperature (e.g., 60° C. or higher).

For example, cobalt (Co) may provide an improved conductivity or a low resistance of the lithium secondary battery, and manganese (Mn) may improve mechanical and electrical stability of the lithium secondary battery.

According to embodiments, in the lithium-transition metal oxide particles having the single-particle shape, particle cracks may be reduced during a disintegration process. Accordingly, an increase in a specific surface area of the lithium-transition metal oxide particles of the single particle shape may be suppressed, thereby reducing the side reactions with the electrolyte solution. Thus, the secondary battery having improved life-span and capacity retention during repeated charge/discharge cycles may be provided.

In example embodiments, a particle diameter (D50) at a 50% volume fraction when accumulated from the smallest particle size in a volume-weighted particle size distribution of active material particles including the lithium-transition metal oxide particles may be in a range from 2 μm to 10 μm.

For example, the particle diameter at the 50% volume fraction or D50 when accumulated from the smallest particle size in the volume-weighted particle size distribution may be measured using a particle size analyzer (PSA). The term “particle diameter” may refer to the longest diameter of the particle.

For example, if the D50 of the lithium-transition metal oxide particles exceeds 10 μm, a diffusion path of lithium ions in the particles may be increased. Accordingly, a resistance of the cathode active material may be increased to lower the capacity properties and efficiency of the secondary battery.

For example, if the D50 of the lithium-transition metal oxide particles is less than 2 μm, a ratio of micro-particles may be increased by excessive grinding conditions to lower the life-span properties of the cathode active material.

In some embodiments, in the above range of the D50 of the active material particles, high-capacity and high-power properties may be obtained while improving the life-span properties.

For example, the D50 of the active material particles including the lithium-transition metal oxide particles may be in a range from 2.5 μm to 5 μm, from 3 μm to 4.5 μm, or from 3.3 μm to 4 μm. In this range, uniformity of the active material particles may be further increased, and the capacity properties and charge-discharge efficiency of the cathode active material may be further improved.

For example, the D50 of the active material particles may be represented as a.

According to embodiments, a volume fraction of particles having a particle size of 2a μm or greater among the active material particles may range from 4% to 15% in the volume-weighted particle size distribution.

For example, in the present disclosure, particles having a particle size of 2a μm or greater may be defined as “macro-particles.”

In an embodiment, the macro-particles may refer to a form in which two or more lithium-transition metal oxide primary particles having the single particle shape are aggregated.

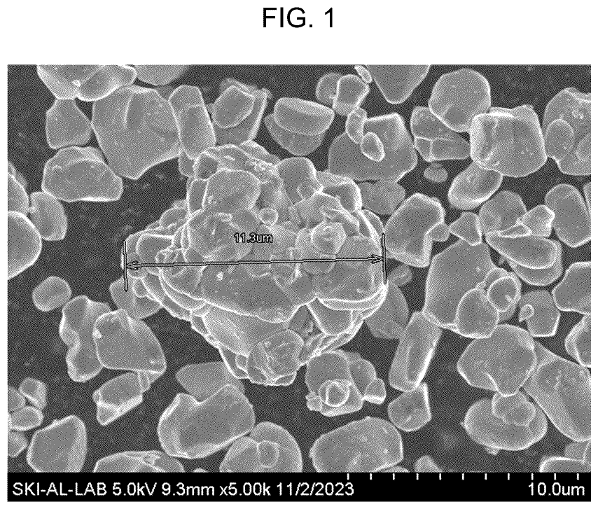

FIG. 1 is a scanning electron microscope (SEM) image of a cathode active material according to embodiments. For example, FIG. 1 may be an SEM image of active material particles including the macro-particles.

Referring to FIG. 1, particles having a particle size of 2 μm or greater, i.e., the macro-particles, may be included among active material particles including the lithium-transition metal oxide particles in the form of the single particle.

For example, the lithium-transition metal oxide particles in the single particle shape may remain in the form of aggregates of multiple single particles during calcination and disintegration processes. Thus, a volume fraction of the macro-particles within the active material particles may be increased to degrade uniformity of the cathode active material during a washing process or a coating process.

For example, if the volume fraction (%) of the macro-particles in the active material particles is less than 4%, excessive disintegration during the calcination and disintegration processes may be increased to cause cracks in the active material particles.

For example, if the volume fraction (%) of the macro-particles exceeds 15%, a particle size distribution of the active material particles may not be uniform. Thus, uniformity of the cathode active material during the washing or the coating process may be excessively degraded.

According to some embodiments, the volume fraction (%) of the macro-particles may be 4.5% or greater, 5% or greater, or 6% or greater. For example, the volume fraction (%) of the macro-particles may be 13% or less, 10% or less, or 9% or less. For example, the volume fraction (%) of the macro-particles in the active material particles may be in a range from 5% to 10% or from 6% to 9%.

In the above range, cracks in the cathode active material particles may be suppressed. Further, disintegration may be more uniformly implemented, and uniformity of the lithium-transition metal oxide particles in the single particle shape may be improved. Accordingly, uniformity of the cathode active material during the washing or coating process may be improved, and life-span properties of the lithium secondary battery may be further improved.

In some embodiments, the active material particles may include particles having a particle diameter of 1 μm or less.

For example, in the present disclosure, particles having a particle diameter of 1 μm or less may be referred to as “micro-particles.”

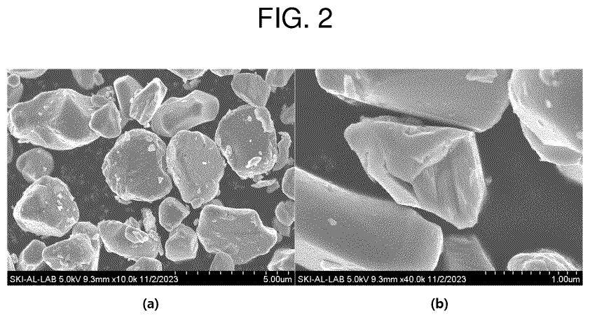

FIG. 2 is a SEM image of a cathode active material according to embodiments. For example, FIG. 2 may be an SEM image of active material particles including the micro-particles.

Referring to FIG. 2, particles having a particle diameter of 1 μm or less, i.e., the micro-particles, may be included among the active material particles. For example, if a crushing pressure increases excessively during the calcination and disintegration process, the micro-particles may be generated (e.g., (a) of FIG. 2) or cracks may occur in the particles (e.g., (b) of FIG. 2). Accordingly. the life-span properties of the secondary battery may be degraded.

In some embodiments, the particles having a particle diameter of 1 μm or less may not be present among the active material particles. For example, during the disintegration process of the lithium-transition metal oxide particles, excessive crushing may be suppressed by adjusting a calcination temperature or a crushing pressure within a predetermined range. Accordingly, the micro-particles may not be present among the active material particles. Thus, the capacity properties of the cathode active material may be improved, and the life-span properties may be enhanced while enhancing an efficiency during repeated charge/discharge cycles.

In some embodiments, the volume fraction of the particles having a diameter of 1 μm or less among the active material particles may be 5% or less in the volume-weighted particle size distribution.

For example, if the volume fraction of the particles having a diameter of 1 μm or less among the active material particles, or the volume fraction of the micro-particles increases excessively, the cathode active material may be overly pulverized to deteriorate structural stability of the cathode active material particles and promote the side reactions with the electrolyte solution. Accordingly, the cathode active material may be deteriorated during repeated charge and discharge cycles, thereby degrading the life-span properties of the secondary battery.

In some embodiments, the volume fraction of the particles having a diameter of 1 μm or less among the active material particles may be in a range from 0.1% to 4.5%, from 0.2% to 3%, from 0.25% to 2%, or from 0.3% to 1%. In the above range, the over-pulverization of the cathode active material particles may be reduced, thereby reducing cracks in the cathode active material particles. Further, deterioration of the cathode active material particles may be suppressed, thereby further improving the capacity retention of the lithium secondary battery during repeated charge/discharge cycles.

According to embodiments of the present disclosure, D50 of the cathode active material particles and the volume fraction of the cathode active material particles may be controlled within predetermined ranges, so that the cathode active material having an improved particle size distribution may be provided. Accordingly, the lithium secondary battery may have improved life-span and capacity properties.

In some embodiments, a span of the cathode active material particles as defined by Formula 1 below may be in a range from 1.0 to 1.5.

$$Span = ( D 90 - D 10 ) / D 50 \qquad [ Formula 1 ]$$

In Equation 1, D50 is a particle diameter at a 50% volume fraction when being accumulated from the smallest particle size in the volume-weighted particle size distribution. D90 is a particle diameter at a 90% volume fraction when being accumulated from the smallest particle size in the volume-weighted particle size distribution of the active material particles. D10 is a particle diameter at a 10% volume fraction when being accumulated from the smallest particle size in the volume-weighted particle size distribution of the active material particles.

For example, the span may represent the particle size variation of the active material particles. As the span decreases, the particle size distribution of the active material particles may become more uniform.

For example, if the span of the active material particles is excessively reduced, the active material particles may be overly pulverized. Thus, excessive cracks of the cathode active material particles may be caused during repeated charge/discharge cycles to degrade structural stability.

For example, if the span of the active material particles is excessively increased, uniformity of the particle size distribution may be lowered to increase a proportion of the micro-particles or the macro-particles in the cathode active material. Accordingly, uniformity of the cathode active material may be reduced during the washing processor the coating process.

In an embodiment, the span of the active material particles may be in a range from 1.1 to 1.4, or from 1.15 to 1.19. In this range, uniformity of the particle size distribution of the active material particles may be improved. Accordingly, the capacity properties and efficiency of the secondary battery may be improved, and the capacity retention during repeated charge and discharge may be further improved.

In some embodiments, D10 of the active material particles may be in a range from 1.3 m to 4 μm, from 1.4 μm to 3 μm, from 1.5 μm to 2.5 μm, or from 1.6 μm to 2 μm.

In an embodiment, D10 of the active material particles may be a/2 μm or greater.

In some embodiments, D90 of the active material particles may be in a range from 4 m to 15 μm, from 5 μm to 10 μm, or from 5.6 μm to 6 μm.

In some embodiments, the cathode active material may include active material particles having D10 and D90 within the above-described ranges, thereby providing improved stability and energy density.

For example, the particle size distribution of the active material particles may be controlled by a particle size and an element content ratio of a precursor (e.g., an NCM precursor) used in preparation of the active material particles, use of a fluxing agent, a heat treatment temperature, a heat treatment time, a heating rate during a heat treatment or a calcination process, a pressure and a time during a disintegration process, a sieve size and a pressure during a sieving or classification process, etc.

In some embodiments, the active material particles may include a coating formed on a surface of the lithium-transition metal oxide particle, and that coating may include a lanthanum (La)-containing compound. Accordingly, an ionic conductivity of the surface of the lithium-transition metal oxide particles may be enhanced.

In an embodiment, the lanthanum-containing compound may include La(OH)₃, La₂O₃, LaPO₄·xH₂O, or La₂(SO₄)₃.

In an embodiment, the coating containing the lanthanum-containing compound may be doped or coated with a metal compound or an inorganic compound. For example, the metal compound or the inorganic compound may include an element of Chemical Formula 1 (e.g., M in Chemical Formula 1). Accordingly, a metal with high electrical conductivity may be doped into a layered structure of the lanthanum-containing compound, thereby improving the power properties of the active material particles. Thus, the power properties of the secondary battery may be maintained even when the high-nickel content cathode active material is prepared as the single particle.

In some embodiments, the cathode active material may be prepared by mixing a lithium precursor and a transition metal precursor with a fluxing agent.

For example, the lithium precursor and the transition metal precursor may be prepared.

The lithium precursor may include, e.g., lithium carbonate, lithium nitrate, lithium acetate, lithium oxide, lithium hydroxide, or the like. These may be used alone or in a combination of two or more therefrom.

For example, the transition metal precursor may be prepared through a co-precipitation reaction of metal salts. The metal salts may include nickel salts, manganese salts and cobalt salts.

Examples of the nickel salt may include nickel sulfate, nickel hydroxide, nickel nitrate, nickel acetate, a hydrate thereof, etc. Examples of the manganese salt may include manganese sulfate, manganese acetate, a hydrate thereof. Examples of the cobalt salt may include cobalt sulfate, cobalt nitrate, cobalt carbonate, a hydrate thereof.

The nickel salt, the manganese salt and the cobalt salt may be mixed with a precipitant and/or a chelating agent in a ratio that may satisfy the content or concentration ratio of each metal described with reference to Chemical Formula 1 to prepare an aqueous solution. The aqueous solution may be co-precipitated in a reactor to prepare the transition metal precursor.

The precipitant may include an alkaline compound such as sodium hydroxide (NaOH), sodium carbonate (Na₂CO₃), or the like. The chelating agent may include, e.g., ammonia water, ammonium carbonate, etc.

A temperature of the co-precipitation reaction may be controlled, e.g., in a range from about 40° C. to about 60° C. A reaction time may be controlled in a range from about 24 hours to 72 hours.

In some embodiments, the lithium precursor and the transition metal precursor may be mixed with the fluxing agent, and then a calcination may be performed.

For example, when mixing and calcining the lithium precursor and the transition metal precursor without adding the fluxing agent, a calcination temperature may be increased to form the single particle shape from the transition metal precursor in the form of the secondary particle. However, if the calcination temperature is excessively increased, an amount of a residual lithium on the surface of the active material particles may be increased. In this case, a gas may be generated due to particle cracks caused by repeated charge/discharge. Accordingly, the capacity retention of the secondary battery may be reduced.

In example embodiments, the above-described fluxing agent is added and mixed so that the fluxing agent and the lithium precursor may react to form an intermediate in a liquid state. The intermediate may react with the transition metal precursor so that a rearrangement phenomenon for reducing a surface tension may occur.

The fluxing agent may induce a solution reprecipitation after the aforementioned rearrangement phenomenon. Pores in the lithium-transition metal oxide particles may be reduced by the solution reprecipitation.

For example, the reprecipitated lithium-transition metal oxide particles may have the single particle shape through densification. Accordingly, particle cracks and gas generation during repeated charge/discharge cycles of the secondary battery may be reduced, and the life-span properties of the battery may be improved.

For example, La(OH)₃ may be used as the fluxing agent. In this case, a coating layer containing the lanthanum-containing compound may be formed on the surface of the lithium-transition metal oxide particles during the calcination process.

In some embodiments, the fluxing agent (e.g., La(OH)₃) may be pulverized prior to the calcination. Accordingly, the particle size may be sufficiently reduced so that a reactivity with the lithium precursor and the transition metal precursor may be enhanced. Thus, the formation of lithium-transition metal oxide particles in the single particle shape and the coating may be easily implemented.

For example, the fluxing agent may be pulverized to have an average particle diameter of 1 μm or less. Accordingly, the lithium-transition metal oxide particles having the uniform single particle shape may be formed. Thus, deterioration of the capacity and life-span properties of the secondary battery due to the non-uniform single particle shape may be prevented.

In some embodiments, when La(OH)₃ is used as the fluxing agent, a content of lanthanum in the fluxing agent may be in a range from 1,000 ppm to 3,000 ppm, or from 1,500 ppm to 2,500 ppm based on a total weight of the lithium-transition metal oxide particles. In the above range, the formation of the single particle shape may be facilitated by the fluxing agent while preventing the formation of non-uniform fine particles (e.g., the aforementioned micro-particles) and large particles (e.g., the aforementioned macro-particles). Thus, the life-span and power properties of the secondary battery may be improved.

For example, if the content of lanthanum increases excessively, the non-uniform large particles may be formed. Further, lanthanum may be doped into the crystal structure of the lithium-transition metal oxide to degrade the power and capacity properties.

For example, if the content of lanthanum decreases excessively, the formation of the single particles may not be sufficient. In the above range, the formation of the single particle may be promoted while preventing excessive formation of the macro-particles. Thus, an initial efficiency of the secondary battery may be increased, and the life-span properties may be further improved while achieving high-capacity properties.

The lithium precursor, the transition metal precursor, and the fluxing agent mixed as described above may be calcined to form the lithium-transition metal oxide particles having the coating that may include a lanthanum-containing compound on a surface thereof.

For example, a metal cation of a compound used as the fluxing agent may have a ionic radius larger than that of nickel, cobalt and manganese. For example, an ionic radius of La³⁺ in La(OH)₃ may be 103.2 pm, an ionic radius of Li⁺ may be 76 pm, an ionic radius of Ni³⁺ may be 56 pm, an ionic radius of Co³⁺ may be 68.5 pm, and an ionic radius of Mn⁴⁺ may be 67 pm.

The La ion having a large ionic radius may not be incorporated into a layered structure, and may remain on the surface in the form of a compound. The fluxing agent remaining on the surface may promote rearrangement, solution re-sedimentation and densification of the lithium-transition metal oxide particles as described above. Thus, the formation of the lithium-transition metal oxide particles of the single particle shape may be promoted at a relatively low calcination temperature.

For example, the fluxing agent remaining on the surface may form a lanthanum-containing coating layer on the surface of the lithium-transition metal oxide particles. The lanthanum-containing coating layer may have a high lithium ion conductivity. Accordingly, the high-capacity and high-power properties of the secondary battery may be implemented while also improving the life-span properties.

In some embodiments, a metal compound or an inorganic compound may be further added when adding and mixing the fluxing agent as described above. For example, the metal compound or the inorganic compound may be added together with La(OH)₃ to a mixture of the lithium precursor and the transition metal precursor.

Accordingly, the coating may be doped or coated with the metal compound or the inorganic compound. For example, the metal compound or the inorganic compound may include an element of the above Chemical Formula 1 (e.g., M in the above Chemical Formula 1). Thus, a metal with high electrical conductivity may be doped into a layered structure of the lanthanum-containing compound, thereby improving power properties of the active material particles. Therefore, even when the cathode active material having a high-Ni content is prepared as the single particle, the power properties of the secondary battery may be maintained.

In some embodiments, a temperature of the calcination may be in a range from 700° C. to 1200° C., or from 800° C. to 1050° C. In the above range, the lithium-transition metal oxide particles in the form of the single particles with a uniform particle size distribution may be formed.

In some embodiments, a temperature of the calcination may satisfy Formulae 2 and 3 below.

$$t 1 - 50 \leq T 1 ( °C ) \leq t 1 + 50 \qquad [ Formula 2 ]$$

In Formula 2, t1 is a temperature defined in Formula 3, and T1 may be a temperature at which the calcination is performed.

$$t 1 ( °C ) = ( - 520 ) \times y + 1300 \qquad [ Formula 3 ]$$

In Formula 3, y may be the same as that in the above Chemical Formula 1.

For example, when the mole fraction (y) of nickel among the elements excluding lithium and oxygen in the lithium-transition metal oxide particles is from 0.6 to 0.99, the calcination temperature may be from 735° C. to 1038° C. For example, when the mole fraction (y) of nickel is 0.6, the calcination temperature may be from 938° C. to 1038° C.

In an embodiment, the nickel mole fraction (y) may be in a range from 0.8 to 0.99, and the calcination temperature may be in a range from about 735° C. to about 934° C.

In some embodiments, the calcined lithium-transition metal oxide particles may be disintegrated using a jet mill. Accordingly, the lithium-transition metal oxide particles aggregated during the calcination process may have the single particle shape.

In some embodiments, a disintegration pressure of the jet mill may be in a range from 1 bar to 5 bar. For example, when the disintegration pressure exceeds 5 bar, an amount of the micro-particles in the lithium-transition metal oxide particles of the single particle shape may be increased, and cracks may occur in the particles.

For example, when the disintegration pressure is less than 1 bar, the particles aggregated during the calcination process may not be disintegrated and may remain.

Accordingly, the uniformity and life-span properties of the cathode active material may be reduced.

In an embodiment, the disintegration pressure may be greater than 1 bar, or greater than 1.3 bar, and the disintegration pressure may be, e.g., less than 4.5 bar, less than 3.5 bar, less than 2.5 bar, or less than 2 bar. In the above range, the lithium-transition metal oxide particles having the volume fractions of micro-particles and macro-particles adjusted to the above-described ranges may be formed.

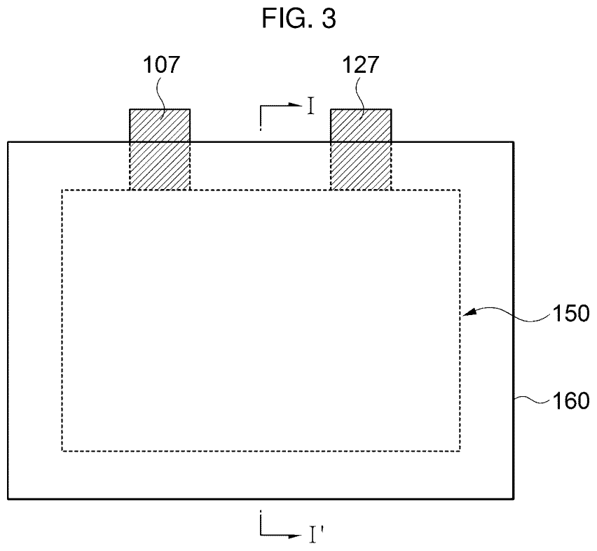

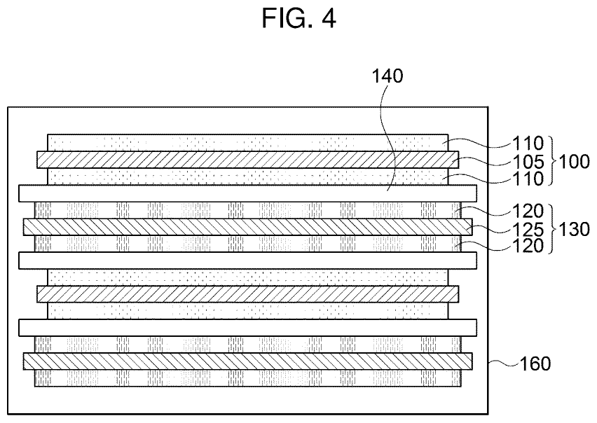

FIGS. 3 and 4 are a schematic plan view and a cross-sectional view, respectively, illustrating a lithium secondary battery in accordance with example embodiments.

Referring to FIGS. 3 and 4, the lithium secondary battery may include a cathode 100 including a cathode active material, an anode 130, and a separator 140.

The cathode 100 may contain a cathode active material layer 110 formed by coating the cathode active material that includes the above-described lithium-transition metal oxide particles on a cathode current collector 105.

For example, a slurry may be prepared by mixing and stirring the above-described lithium-transition metal oxide particles with a binder, a conductive material, and/or a dispersant in a solvent. The slurry may be coated on the cathode current collector 105, and then dried and pressed to form the cathode.

The cathode current collector 105 may include, e.g., stainless steel, nickel, aluminum, titanium, copper, or an alloy thereof, and may include, e.g., aluminum or an aluminum alloy.

The binder may include, e.g., an organic binder such as vinylidene fluoride-hexafluoropropylene copolymer (PVDF-co-HFP), polyvinylidene fluoride (PVDF), polyacrylonitrile, polymethylmethacrylate, etc., or an aqueous binder such as styrene-butadiene rubber (SBR) that may be used together with a thickener such as carboxymethyl cellulose (CMC).

For example, a PVDF-based binder may be used as a binder for forming the cathode. In this case, an amount of the binder for forming the cathode active material layer 110 may be reduced, and an amount of the cathode active material may be relatively increased. Thus, the power and capacity of the secondary battery may be enhanced.

The conductive material may be included to promote an electron transfer between the active material particles. For example, the conductive material may include a carbon-based conductive material such as graphite, carbon black, graphene, carbon nanotube, etc., and/or a metal-based conductive material including tin, tin oxide, titanium oxide, a perovskite material such as LaSrCoO₃, LaSrMnO₃, etc.

The anode 130 may include an anode current collector 125 and an anode active material layer 120 formed by coating an anode active material on the anode current collector 125.

The anode active material may include a material capable of intercalating and de-intercalating lithium ions known in the related art without any particular limitation. For example, a carbon-based material such as a crystalline carbon, an amorphous carbon, a carbon composite, a carbon fiber, etc.; a lithium alloy; silicon, tin, etc., may be used.

Examples of the amorphous carbon may include hard carbon, coke, a mesocarbon microbead (MCMB) fired at 1,500° C. or less, a mesophase pitch-based carbon fiber (MPCF). Examples of the crystalline carbon may include a graphite-based carbon such as natural graphite, a graphitized coke, a graphitized MCMB, a graphitized MPCF, etc. Elements included in the lithium alloy may include aluminum, zinc, bismuth, cadmium, antimony, silicon, lead, tin, gallium, indium, etc.

The anode current collector 125 may include, e.g., gold, stainless steel, nickel, aluminum, titanium, copper, or an alloy thereof, and may include, e.g., copper or a copper alloy.

In some embodiments, a slurry may be prepared by mixing and stirring the anode active material above with a binder, a conductive material, and/or a dispersant in a solvent. The slurry may be coated on the anode current collector, and then dried and presses to prepare the anode 130.

Materials substantially the same as or similar to the above-described materials may be used as the binder and the conductive material. In some embodiments, the binder for forming the anode may include an aqueous binder such as styrene-butadiene rubber (SBR) for consistency with the carbon-based active material, and may be used together with a thickener such as carboxymethyl cellulose (CMC).

The separator 140 may be interposed between the cathode 100 and the anode 130. The separator 140 may include a porous polymer film formed of a polyolefin-based polymer such as an ethylene homopolymer, a propylene homopolymer, an ethylene/butene copolymer, an ethylene/hexene copolymer, an ethylene/methacrylate copolymer, or the like. The separator 140 may include a nonwoven fabric formed of a glass fiber having a high melting point, a polyethylene terephthalate fiber, or the like.

In example embodiments, an electrode cell may be defined by the cathode 100, the anode 130, and the separator 140, and a plurality of the electrode cells may be stacked to form an electrode assembly 150 in the form of, e.g., a jelly roll. For example, the electrode assembly 150 may be formed by winding, stacking, folding, or the like of the separator 140.

The electrode assembly may be accommodated together with an electrolyte in an outer case 160 to define a lithium secondary battery. According to embodiments, a non-aqueous electrolyte solution may be used as the electrolyte.

The non-aqueous electrolyte solution may include a lithium salt as the electrolyte and an organic solvent. For example, the lithium salt may be expressed as Li⁺X⁻, and examples of an anion (X—) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, or the like. These may be used alone or in a combination of two or more therefrom.

As illustrated in FIG. 3, electrode tabs (a cathode tab and an anode tab) included in each electrode cell may protrude from the cathode current collector 105 and the anode current collector 125, respectively, to extend to one side of the outer case 160. The electrode tabs may be fused together with the one side of the outer case 160 to be connected to an electrode lead (a cathode lead 107 and an anode lead 127) which are extended or exposed to an outside of the case 160.

For example, the lithium secondary battery may be manufactured in a cylindrical type using a can, a prismatic type, a pouch type, or a coin type.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Examples and Comparative Examples

### (1) Preparation of Transition Metal Precursor

NiSO₄, CoSO₄ and MnSO₄ were mixed in a molar ratio of 0.88:0.09:0.03 using distilled water bubbled with N₂ for 24 hours to remove dissolved oxygen. The solution was placed in a reactor at 50° C., and a co-precipitation reaction was conducted for 48 hours using NaOH and NH₄OH as a precipitant and a chelating agent, respectively, to obtain Ni_{0.88}Co_{0.09}Mn_{0.03}(OH)₂ as a transition metal precursor. The obtained precursor was dried at 80° C. for 12 hours and then re-dried at 110° C. for 12 hours.

### (2) Preparation of Cathode Active Material

The transition metal precursor, LiOH·H₂O as a lithium precursor, and La(OH)₃ as a fluxing agent were placed in a dry high-speed mixer and mixed so that a molar ratio of transition metals (Ni, Co, Mn) and Li was adjusted in 1:1.03.

Thereafter, the mixed powder was placed in a calcination furnace, and heated to a temperature of about 840° C. to 900° C. at a heating rate of 2° C./min while supplying oxygen at a flow rate of 100 mL/min to maintain an oxygen concentration in the furnace at 95% or higher.

The elevated temperature was maintained for 10 hours. After the calcination, a fine pulverization was performed using a jet mill (micronizer, Sturtevant) to obtain a cathode active material.

In Examples and Comparative Examples, the calcination temperature (° C.), a lanthanum content (ppm) based on a total weight of the lithium-transition metal composite oxide particles, and a disintegration pressure (bar) of the jet mill were adjusted as shown in Table 1 below.

### (3) Fabrication of Lithium Secondary Battery

A secondary battery was fabricated using the above-described cathode active material. Specifically, a cathode mixture was prepared by mixing the cathode active material, Denka Black as a conductive material, and PVDF as a binder in a mass ratio of 93:5:2. The mixture was coated on an aluminum current collector, and then dried and pressed to prepare a cathode. A target electrode density after the pressing of the cathode was adjusted to 3.6 to 3.7 g/cc.

A lithium metal was used as an anode active material.

The cathode and the anode prepared as described above were notched into circular shapes having diameters of Φ14 and Φ16, respectively. The cathode and the anode were stacked with a separator (polyethylene, thickness: 13 μm) notched to Φ19 interposed therebetween to form an electrode cell. The electrode cell was placed in a coin cell outer case with a diameter of 20 mm and a height of 1.6 mm, assembled after injecting an electrolyte solution, and aged for more than 12 hours so that the electrolyte solution could impregnate an inside of the electrode.

A 1 M LiPF6 solution using a mixed solvent of EC/EMC (30/70; volume ratio) was used as the electrolyte solution.

The secondary battery fabricated as described above was subjected to a formation charge and discharge (charge conditions: CC-CV 0.1C, 4.3V, 0.005C cut-off, discharge conditions: CC 0.1C, 3V cut-off).

TABLE 1

| | calcination | La content | Jet-mill disintegration |
|---|---|---|---|
| | temperature (° C.) | (ppm) | pressure (bar) |
| Example 1 | 840 | 2000 | 1.5 |
| Example 2 | 840 | 2000 | 2.5 |
| Example 3 | 840 | 2000 | 3.5 |
| Example 4 | 840 | 2000 | 1.0 |
| Example 5 | 860 | 2000 | 1.5 |
| Example 6 | 880 | 0 | 1.5 |
| Example 7 | 820 | 2000 | 1.5 |
| Example 8 | 900 | 2000 | 1.5 |
| Comparative | 840 | 0 | 1.5 |
| Example 1 | | | |
| Comparative | 860 | 2000 | 4.5 |
| Example 2 | | | |

### Experimental Example

### (1) Measurement of Particle Size Distribution

A volume-weighted particle size distribution of each cathode active material of Examples and Comparative Examples was measured using a laser diffraction particle size measurement device (Microtrac S3500 Extended).

When the particles were accumulated from those having a smaller diameter, D10 represents a particle size at a 10% volume fraction, D50 represents a particle size at a 50% volume fraction, and D90 represents a particle size at a 90% volume fraction.

Particles having a diameter of 1 μm or less were classified as micro-particles, and particles having a diameter greater than or equal to twice D50 were classified as macro-particles.

A span (dimensionless) was calculated as (D90-D10)/D50.

Further, cross-sections of the cathode active materials of Example 1, Comparative Examples 1 and Comparative Examples 2 were observed using a scanning electron microscope (SEM). The measurement results are shown in Table 2 below.

TABLE 2

| | | | | volume fraction | volume fraction | |
|---|---|---|---|---|---|---|
| | | | | of micro- | of macro- | |
| | D10 (μm) | D50(μm) | D90(μm) | particles (%) | particles (%) | span |
| Example 1 | 1.91 | 3.46 | 5.97 | 0.5 | 7.2 | 1.17 |
| Example 2 | 1.72 | 3.21 | 5.79 | 1.3 | 9 | 1.27 |
| Example 3 | 1.33 | 2.62 | 4.73 | 4.7 | 8.4 | 1.3 |
| Example 4 | 2.24 | 4.82 | 9.87 | 0.4 | 14.7 | 1.58 |
| Example 5 | 2.16 | 4.07 | 6.63 | 0.4 | 5.5 | 1.1 |
| Example 6 | 2.50 | 4.05 | 6.67 | 0 | 4.8 | 1.03 |
| Example 7 | 1.80 | 3.76 | 6.89 | 3.1 | 11.8 | 1.35 |
| Example 8 | 2.7 | 5.01 | 8.36 | 0 | 6.6 | 1.13 |
| Comparative | 1.19 | 2.48 | 6.5 | 6.3 | 18.3 | 2.14 |
| Example 1 | | | | | | |
| Comparative | 1.68 | 2.97 | 5.05 | 4.5 | 1.4 | 1.14 |
| Example 2 | | | | | | |

Referring to Table 2, in the cathode active materials according to Examples, D50 was controlled in a range from 2 μm to 5 μm, and a cumulative relative particle amount (%) of the macro-particles was controlled in a range from 4% to 15%.

The cathode active materials according to Examples in which the calcination temperature and the disintegration pressure were adjusted to appropriate ranges had overall uniform particle size distributions.

In Comparative Examples in which the calcination temperature or the disintegration pressure was not in the appropriate range, overall non-uniform particle size distributions were provided when compared to those from Examples.

For example, in Comparative Example 1 where the fluxing agent was not used and Comparative Example 2 where the disintegration pressure was increased, non-uniform particle size distributions were provided.

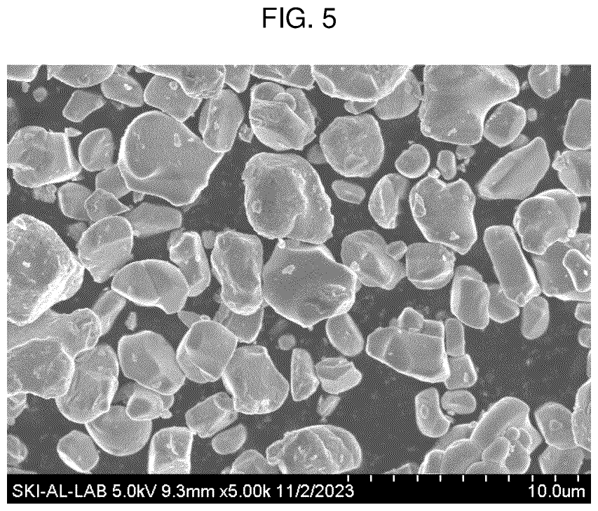

FIGS. 5 to 7 are SEM images of cathode active materials for a lithium secondary battery according to Example 1, Example 4 and Comparative Example 1, respectively.

Referring to FIG. 5, the cathode active material according to Example 1 prepared at the calcination temperature of 840° C. and the disintegration pressure of 1.5 bar had an overall uniform single-particle morphology. Generation of cracks and micro-particles were suppressed, and a proper amount of the macro-particles by agglomeration of two or more particles were also formed.

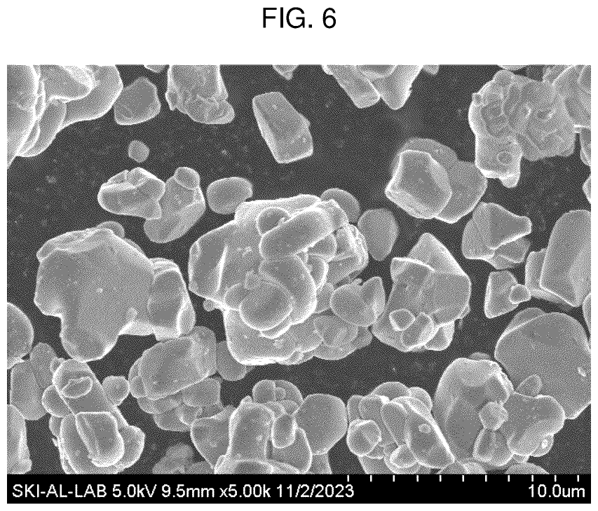

Referring to FIG. 6, in Example 4 where the disintegration pressure was lowered, the amount of the macro-particles by agglomeration of two or more particles, were increased while remaining a small amount of the micro-particles.

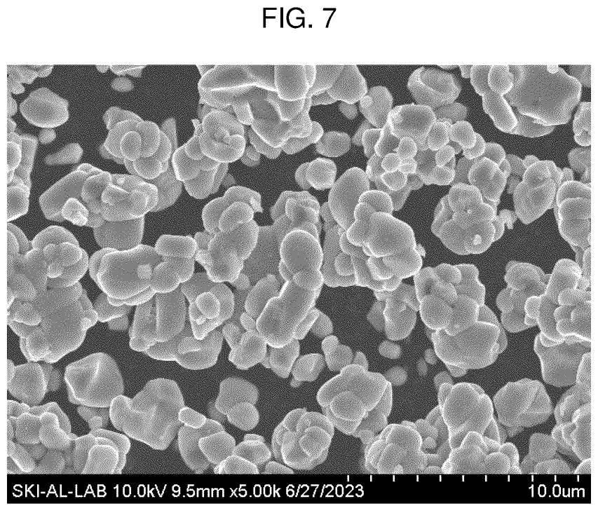

Referring to FIG. 7, the cathode active material according to Comparative Example 1 where the fluxing agent was not used had a relatively low D50. Further, sufficient single particle formation was not implemented to cause agglomeration of multiple small particles, and a uniform single-particle morphology was not obtained.

### (2) Measurement of Capacity Retention (Life-Pan Property) During Repeated Charge and Discharge

The lithium secondary batteries according to Examples and Comparative Examples were charged (CC/CV 0.5 C, 4.3 V, 0.05 C cut-off) and discharged (CC 1.0 C, 3.0 V cut-off) by 200 cycles in a chamber of 45° C. A capacity retention was evaluated as a percentage of a discharge capacity at the 200th cycles relative to a discharge capacity at the 1st cycle.

The evaluation results are shown in Table 3 below.

TABLE 3

| | capacity retention |
|---|---|
| | (200 cycles) (%) |
| Example 1 | 80 |
| Example 2 | 75 |
| Example 3 | 73 |
| Example 4 | 81 |
| Example 5 | 77 |
| Example 6 | 76 |
| Example 7 | 74 |
| Example 8 | 77 |
| Comparative | 69 |
| Example 1 | |
| Comparative | 70 |
| Example 2 | |

Referring to Table 3, in Examples where a cumulative relative particle content (%) of the macro-particles was controlled in a range from 4% and 15%, the life-span properties were improved.

In Example 4 where the disintegration pressure was reduced, the uniform single-particle morphology was achieved and the amount of the micro-particles was reduced. Thus, side reactions with the electrolyte solution were reduced to provide the improved life-span property.

In Example 7 where the calcination temperature was reduced, a particle growth was insufficient compared to those from other Examples. Accordingly, the life-span property of the secondary battery was relatively degraded.

In Comparative Example 1 where the calcination temperature was reduced and the fluxing agent was not used, sufficient single-particle formation was not implemented. Further, particle agglomeration was not sufficiently disintegrated. Accordingly, the particle size distribution became non-uniform to deteriorate the life-span property.

In Comparative Example 2 where the disintegration pressure was increased and the cumulative relative particle content was less than 4%, particle cracks were increased compared to those from Examples and other Comparative Examples to further degrade the capacity retention.

In Comparative Example 2, the calcination temperature was adjusted to 860° C., but the amount of the micro-powder was increased due to an over-pulverization. Accordingly, the capacity retention was further decreased.

What is claimed is:

1. A cathode active material for a lithium secondary battery comprising active material particles that comprise lithium-transition metal oxide particles having a single particle shape,
wherein, a particle diameter (D50) of the active material particles at a volume fraction of 50% in a volume-weighted particle size distribution accumulated from particles having the smallest particle diameter is in a range from 2 μm to 10 μm,
wherein a volume fraction of particles having a particle diameter of 2a μm or greater among the active material particles is in a range from 4% to 15%, and a represents the D50 of the active material particles.

2. A cathode active material for a lithium secondary battery of claim 1, wherein the D50 of the active material particles is in a range from 2.5 μm to 5 μm.

3. The cathode active material for a lithium secondary battery of claim 1, wherein the volume fraction of particles having the particle diameter of 2a μm or greater among the active material particles is in a range from 5% to 10%.

4. The cathode active material for a lithium secondary battery of claim 1, wherein a volume fraction of particles having a particle diameter of 1 μm or less among the active material particles is 5% or less.

5. The cathode active material for a lithium secondary battery of claim 1, wherein the volume fraction of particles having the particle diameter of 1 μm or less among the active material particles is in a range from 0.1% to 4.5%.

6. The cathode active material for a lithium secondary battery of claim 1, wherein a span of the active material particles defined by Formula 1 is in a range from 1.0 to 1.5:
$$Span = ( D 90 - D 10 ) / D 50 \qquad [ Formula 1 ]$$
wherein, in Equation 1, D50 is a particle diameter of the active material particles at the volume fraction of 50% in the volume-weighted particle size distribution accumulated from particles having the smallest particle diameter, D90 is a particle diameter of the active material particles at a volume fraction of 90% in the volume-weighted particle size distribution accumulated from particles having the smallest particle diameter, and D10 is a particle diameter of the active material particles at a volume fraction of 10% in the volume-weighted particle size distribution accumulated from particles having the smallest particle diameter.

7. The cathode active material for a lithium secondary battery of claim 6, wherein the span of the active material particles is in a range from 1.1 to 1.4.

8. The cathode active material for a lithium secondary battery of claim 6, wherein the D10 of the active material particles is in a range from 1.3 μm to 4 μm.

9. The cathode active material for a lithium secondary battery of claim 6, wherein the D90 of the active material particles is in a range from 4 μm to 15 μm.

10. The cathode active material for a lithium secondary battery of claim 1, wherein the lithium-transition metal oxide particles comprise nickel, and a mole fraction of nickel among elements excluding lithium and oxygen in the lithium-transition metal oxide particles is 0.6 or greater.

11. The cathode active material for a lithium secondary battery of claim 10,
wherein the lithium-transition metal oxide particles further comprise at least one element selected from the group consisting of Na, Mg, Ca, Sr, Ba, La, Y, Ti, Zr, Hf, V, Nb, Ta, Cr, Mo, W, Mn, Co, Fe, Cu, Ag, Zn, B, Al, Ga, C, Si and Sn.

12. The cathode active material for a lithium secondary battery of claim 11, wherein the lithium-transition metal oxide particles comprise lanthanum in a content from 500 ppm to 4,000 ppm based on a total weight of the lithium-transition metal oxide particles.

13. A lithium secondary battery, comprising:
a cathode comprising the cathode active material for a lithium secondary battery of claim 1; and
an anode facing the cathode.
